(19) United States
(12) Patent Application Publication
(10) Pub. No.: US 2026/0155639 A1
(43) Pub. Date: Jun. 4, 2026

(54) FOLDING ELECTRICAL RECEPTACLE MOUNT

(71) Applicant: Bobby Conner, Huntsville, TX (US)

(72) Inventor: Bobby Conner, Huntsville, TX (US)

(21) Appl. No.: 19/407,479

(22) Filed: Dec. 3, 2025

Related U.S. Application Data
(60) Provisional application No. 63/727,360, filed on Dec. 3, 2024.

(51) Int. Cl. H02G 3/12

(52) U.S. Cl. CPC H02G 3/12

(57) ABSTRACT

A bracket includes an electrical receptacle having a folding guideline, having a stackable flat stowage mode, and having a folded non-flat assembled mode.

### RELATED APPLICATION

The present application claims priority to, and incorporates by reference the entirety of, U.S. provisional application No. 63/727,360 filed Dec. 3, 2024.

### TECHNICAL FIELD

Various embodiments relate generally to support plates and outlet boxes.

### BACKGROUND

In some industries, openings are defined on certain objects. For example, openings are defined in some homes and cars in order to provide sunlight or visibility to the outside.

Openings may also be provided to receive another object. For example, openings may receive windowpanes that are positioned in the defined space. By receiving a windowpane, the opening may, for example, provide better protection from the elements.

### BRIEF DESCRIPTION OF THE DRAWINGS

FIG. 1 depicts an illustrative electrical receptacle bracket with guidelines and an aperture.

FIG. 2 depicts an illustrative electrical receptacle bracket with an outlet box positioned within the aperture.

FIG. 3 depicts a front perspective view of an illustrative electrical receptacle bracket with foldable sections folded out.

FIG. 4 depicts a back view of the illustrative electrical receptacle bracket with foldable sections folded out shown in FIG. 3.

FIG. 5 depicts a front view of the illustrative electrical receptacle bracket with foldable sections folded out shown in FIG. 3.

FIG. 6 depicts a schematic diagram with dimensions of an illustrative electrical receptable bracket.

FIG. 7 depicts a front perspective view of several illustrative electrical receptable brackets stacked onto one another.

FIG. 8 depicts an illustrative embodiment of an installed electrical receptable bracket.

Like reference symbols in the various drawings indicate like elements.

### DETAILED DESCRIPTION OF ILLUSTRATIVE EMBODIMENTS

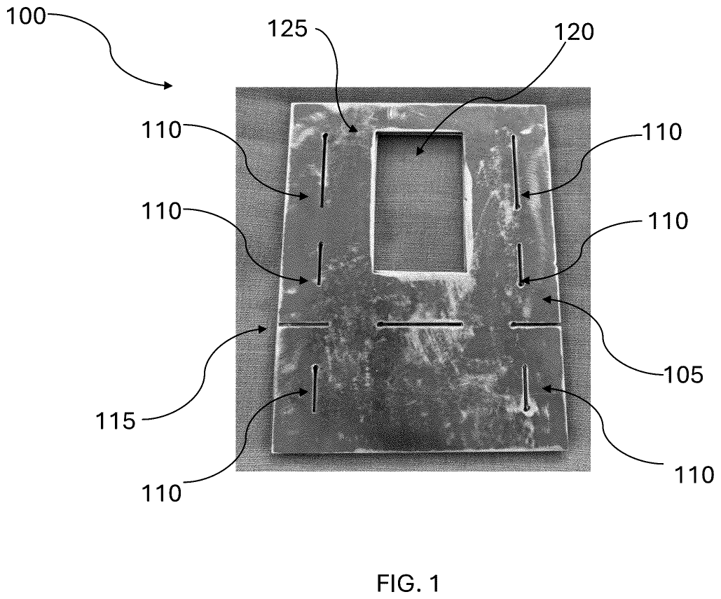

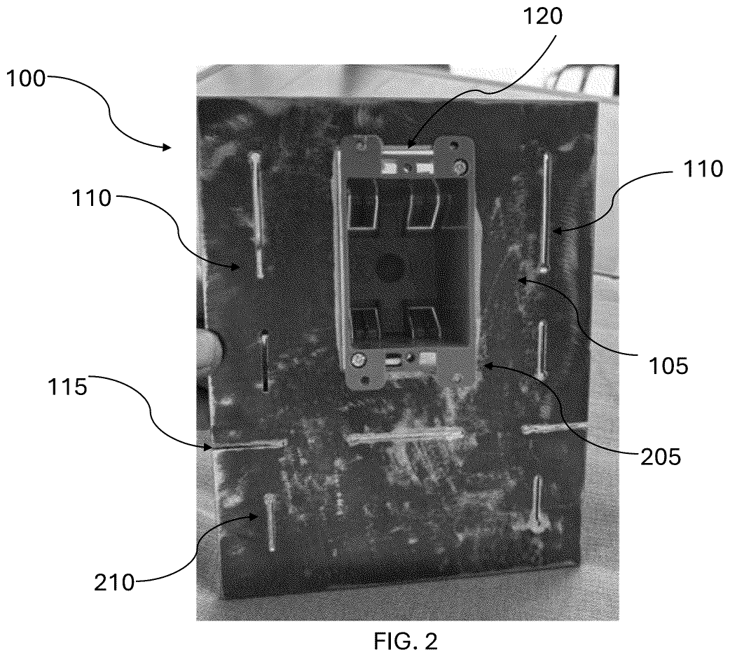

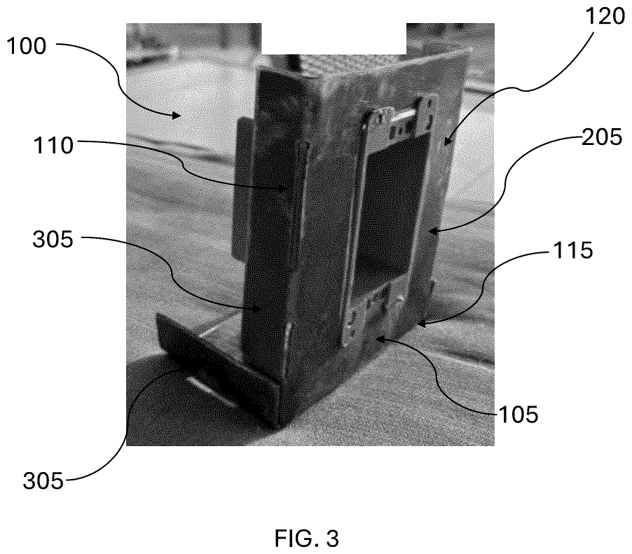

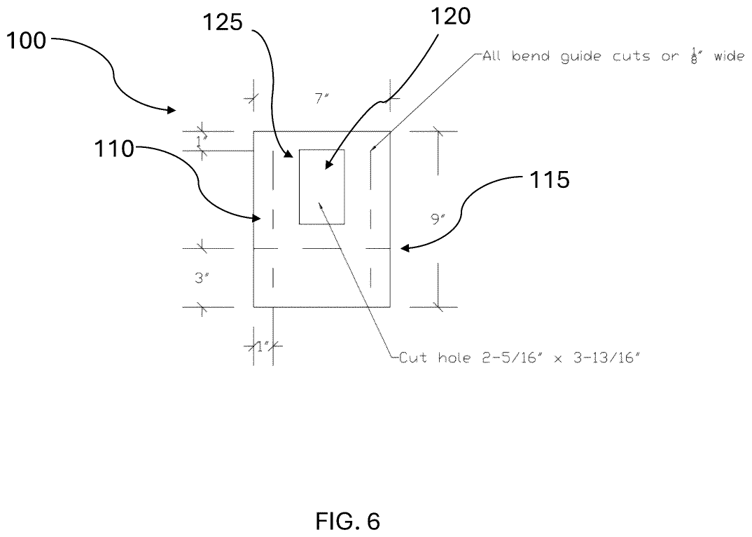

To aid understanding, this document is organized as follows. First, to help introduce discussion of various embodiments, a bracket, reinforceable member, vertical guidelines, and horizontal guidelines are introduced with reference to FIGS. 1-2. Second, that introduction leads into a description with reference to FIGS. 3-5 of some illustrative embodiments of the foldable sections of the reinforceable member. FIGS. 6-8 discuss some illustrative embodiments, illustrative dimensions, and installation of the folding electrical receptacle mount.

FIG. 1 depicts an illustrative electrical receptacle bracket with guidelines and an aperture. A bracket 100 may, for example, include a reinforcement member 105. The reinforcement member 105 may, for example, include a plurality of vertical guidelines 110 and a plurality of horizontal guidelines 115. The vertical guidelines 110 and the horizontal guidelines 115 may, for example, be perforated. The reinforcement member 105 may, for example, also define an aperture 120 with an aperture perimeter 125. For example, the aperture 120 is configured to receive an outlet box. The aperture 120 may, for example, comprise several sizes to accommodate a variety of different outlet boxes and electrical components. The position of the aperture 120 may, for example, be predetermined.

In accordance with an illustrative embodiment, the vertical guidelines 110 and the horizontal guidelines 115 may, for example, act as fold lines to reversibly fold or bend the reinforcement member 105. The reversibility of the reinforcement member 105 may, for example, provide the bracket 100 with a stowage mode, as depicted in FIG. 1, and an assembled mode. The bracket 100 in stowage mode extends along a single plane. The bracket 100 in an assembled mode may, for example, fold along the vertical guidelines 110 and the horizontal guidelines 115. Advantageously, the bracket 100 in stowage mode is easier to ship in large amounts since it is flat. In an alternative, in the stowage mode the bracket is not flat; it is partially bent along at least one of the guidelines but is still stackable. The stowage mode may, for example, takes up less space by volume than other arrangements. By taking up less space, stowage mode may reduce transportation costs when numerous brackets 100 are shipped.

In accordance with an illustrative embodiment, the reinforcement member 105 may, for example, include a pair of the vertical guidelines 110. The pair of the vertical guidelines 110 may, for example, extend along a longitudinal direction of the reinforcement member 105 on opposing sides of the aperture 120. The reinforcement member 105 may, for example, include the horizontal guidelines 115. The horizontal guidelines 115 may, for example, extend along the latitudinal direction of the reinforcement member 105. The vertical guidelines 110 and the horizontal guidelines 115 may, for example, be configured to increase the structural strength of the reinforcement member 105 when folded.

In accordance with an illustrative embodiment, the folding or bending of the reinforcement member 105 at the vertical guidelines 110 and the horizontal guidelines 115 may, for example, be performed in several ways. For example, the reinforcement member 105 may be bent by hand, using tools such as manual folding machines, or using hydraulic folding or bending machines. The bending of the reinforcement member 105 may also be performed by other machines and methods known to those skilled in the art.

In some embodiments, the bracket 100 is formed from steel. In some embodiments, the bracket 100 is formed from stainless steel. In some embodiments, the bracket 100 is formed from aluminum. In some embodiments, a portion of the bracket 100 outside the guidelines is formed from cast iron. In some embodiments, the bracket 100 is formed from a combination of two or more materials, including by way of illustration two or more of: steel, 24 gauge hot roll steel, stainless steel, brass, aluminum, or cast iron (which is not to say that these listed materials are equivalent to one another or universally interchangeable with one another).

In some embodiments, the bracket 100 is formed from a sheet of material using a die-cutting process. In some embodiments, the bracket 100 is formed from a sheet of material by a digital cutting machine. In some embodiments, the bracket 100 is formed from a sheet of material using a laser cutting process. In some embodiments, the bracket 100 is formed from a sheet of material using a plasma cutting process. In some embodiments, the bracket 100 is formed from a sheet of material using a high pressure water cutting process. In some embodiments, the bracket 100 is formed from a sheet of material using a punch process.

In some embodiments, the guidelines have a V-shaped portion in cross-section, such that when the folds are made the mitered materials on the two sides of the folded guideline do not interfere with one another. The angles of the V-shaped portion are about 45 degrees. The V-shaped portion is not full depth, as that would create an unacceptable weakness when the fold is made. In some cases, the top corners are mitered. In some, the bottom corners are not mitered.

In some embodiments, an area shown in some figures as where the bracket is screwed to a purlin are wider than is shown, and instead of screwing through a hole to the purlin a screw is placed adjacent the bracket and used to clamp the bracket to the purlin. This allows horizontal adjustments to bracket position, e.g., up to two inches in some cases, before final placement. In some cases, a 3-32^{nd} screw is placed through a slot into the purlin to clamp the bracket base.

In some embodiments, a single bracket die includes punches (punch-out portions) such that it can be configured for use with either a single gauge box or a double gauge box.

Some embodiments include a pad with screw down slots on the side of the bracket, which allows the bracket to be mounted to a vertical purlin.

FIG. 2 depicts an illustrative electrical receptacle bracket with an outlet box positioned in the aperture 120. The aperture 120 may, for example, be configured to receive an outlet box 205. The outlet box 205 may, for example, be fastened to the aperture perimeter 125. The outlet box 205 may, for example, fasten to the aperture perimeter 125 with screws, nuts, nails, bolts, washers, anchors, and rivets. The outlet box 205 may also fasten to the aperture perimeter 125 using other means known to those skilled in the art. The outlet box 205 may comprise of a variety of dimensions. For example, the outlet box 205 may be two inches wide, two inches tall, and one inch deep. In this example, the dimensions of the aperture 120 may correspond to the outlet box 205 exactly or it may correspond to the outlet box 205 so that the dimensions of the aperture 120 are greater or less than the outlet box 205. The variety of dimensions advantageously provides for different types of electrical outlets and receptacles to fit within the outlet box 205.

The vertical guidelines 110 and the horizontal guidelines 115 defined in the reinforcement member 105 may also, for example, include guideline apertures 210. The guideline apertures 210 may, for example, be configured to fasten the reinforcement member 105 to surfaces. The guideline apertures 210 may, for example, fasten to a surface when the reinforcement member 105 is in stowage mode or assembled mode.

In accordance with an illustrative embodiment, the bracket 100 may, for example, include a reinforcement member 105. The reinforcement member 105 may, for example, include the vertical guidelines 110, the horizontal guidelines 115, and the aperture 120. The vertical guidelines 110 may, for example, extend along the longitudinal direction of the reinforcement member 105. The horizontal guidelines 115 may, for example, extend along the latitudinal direction of the reinforcement member 105. The reinforcement member 105 may, for example, extend along a single plane. The reinforcement member 105 may also, for example, fold along the vertical guidelines 110 and the horizontal guidelines 115.

In accordance with an illustrative embodiment, electrical components may, for example, be installed or replaced from the outlet box 205 in the aperture 120. If certain electrical components fall out of code, then these components may, for example, be replaced from the outlet box 205 to maintain code compliance.

FIG. 3 depicts an illustrative electrical receptacle bracket with foldable sections folded out. The vertical guidelines 110 and the horizontal guidelines 115 define foldable sections 305. The foldable sections 305 may fold or bend in a predetermined manner along the vertical guidelines 110 and the horizontal guidelines 115. The reinforceable member 105 is in an assembled mode when the foldable sections 305 are folded out. In some embodiments, the foldable sections 305 along the vertical guidelines 110 or the horizontal guidelines 115 fold first and the remaining foldable sections 305 are folded subsequently. In other embodiments, the foldable sections 305 along the guidelines 110, 115 are folded or bent in any order. The foldable sections 305 may, for example, advantageously fold or bend to a variety of different orientations. The varying orientations may, for example, advantageously enable the reinforceable member 105 to be folded or bent onto a variety of different surfaces that have similar folds or bends. When the reinforceable member 105 has a corresponding orientation as the surface the reinforceable member 105 is being attached to, the reinforceable member 105 may, for example, fittingly attach and fasten to the surface. The reinforceable member 105 may, for example, adjust to orientations other than 90 degrees.

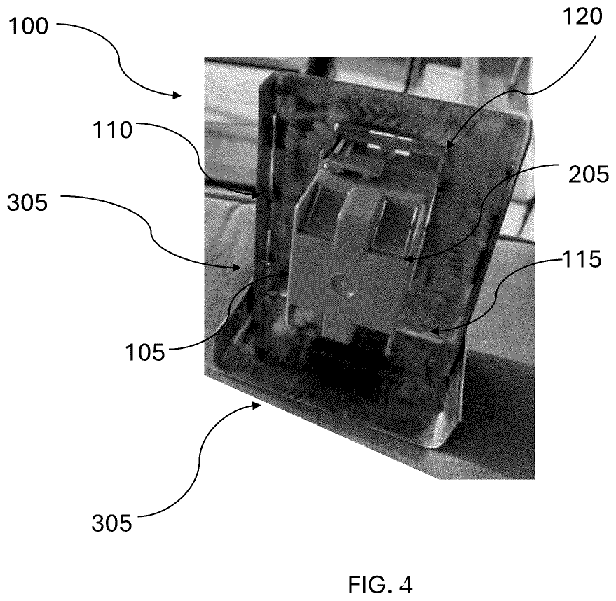

FIG. 4 depicts a back view of the illustrative electrical receptacle bracket with the foldable sections folded out shown in FIG. 3. The foldable sections 305 may, for example, extend in a parallel direction with the outlet box 205. The foldable sections 305 may, for example, be configured to extend around the outlet box 205.

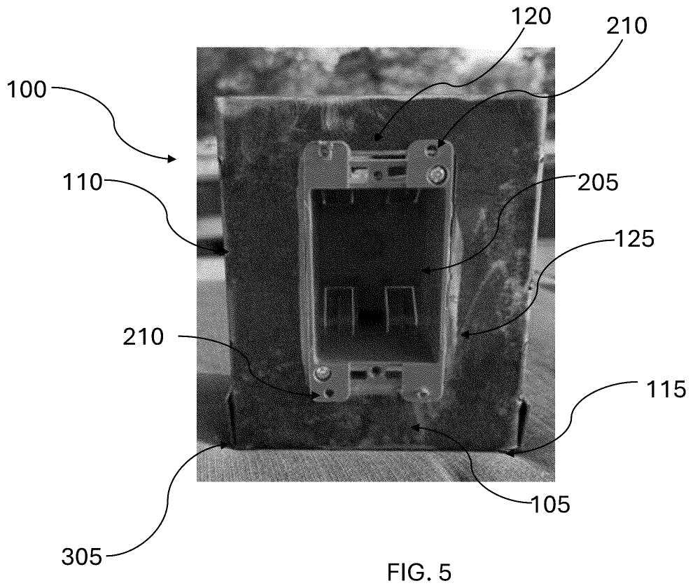

FIG. 5 depicts a front view of the illustrative electrical receptacle bracket with foldable sections folded out shown in FIG. 3. The outlet box 205 may, for example, include fastener apertures 505. The fastener apertures 505 may, for example, be configured to receive fasteners. The fastener aperture 505 and fasteners may, for example, connect the reinforceable member 105 and the outlet box 205. This connection may, for example, reinforce the outlet box 205 as the structural rigidity of the reinforceable member 105 supports and protects electrical components within the outlet box 205.

In accordance with another illustrative embodiment, the design of the bracket 100 may, for example, be configured to mount to metal building purlins. The design of the bracket 100 may include, for example, pre-drilled fastener holes for securing the bracket 100 to purlins. This design of the bracket may, for example, eliminate the need for additional framing or support structures and advantageously enable flexible positioning along the purlin's length.

In accordance with another illustrative embodiment, the design of the bracket 100 may, for example, be configured to mount to sheet metal walls. The design of the bracket 100 may, for example, include a lip or edge that secures and sandwiches the sheet metal wall. The design of the bracket 100 may, for example, provide a finished look from both interior and exterior perspectives and the design may strengthen the integrity of the wall structure at the point of electrical installation and allow for easier and more flexible electrical planning in metal structure designs.

In an illustrative embodiment, the bracket 100 may, for example, eliminate the need for exposed conduits, providing a smoother design. The bracket 100 may also, for example, reduce installation time and labor costs compared to traditional methods. For example, the bracket 100 may adjust to a variety of orientations, enabling a user to only need the bracket 100 as opposed to a plurality of different mounts for each orientation.

In accordance with an illustrative embodiment, the bracket 100 may, for example, be used in commercial metal buildings and warehouses, agricultural structures, residential metal buildings, and prefabricated metal building kits.

FIG. 6 depicts a schematic diagram with dimensions of an illustrative electrical receptable bracket. The vertical guidelines 110 may, for example, be one inch from the length side of the bracket 100 and the horizontal guidelines 115 may, for example, be three inches from the width side of the bracket 100. The length side of the bracket 100 may, for example, be nine inches long and the width side of the bracket 100 may, for example, be seven inches long. The aperture 120 may, for example, be about two inches wide and about 4 inches long.

In accordance with an illustrative embodiment, the bracket 100, the vertical guidelines 110, the horizontal guidelines 115, the aperture 120, and the aperture perimeter 125 may, for example, comprise of varying lengths.

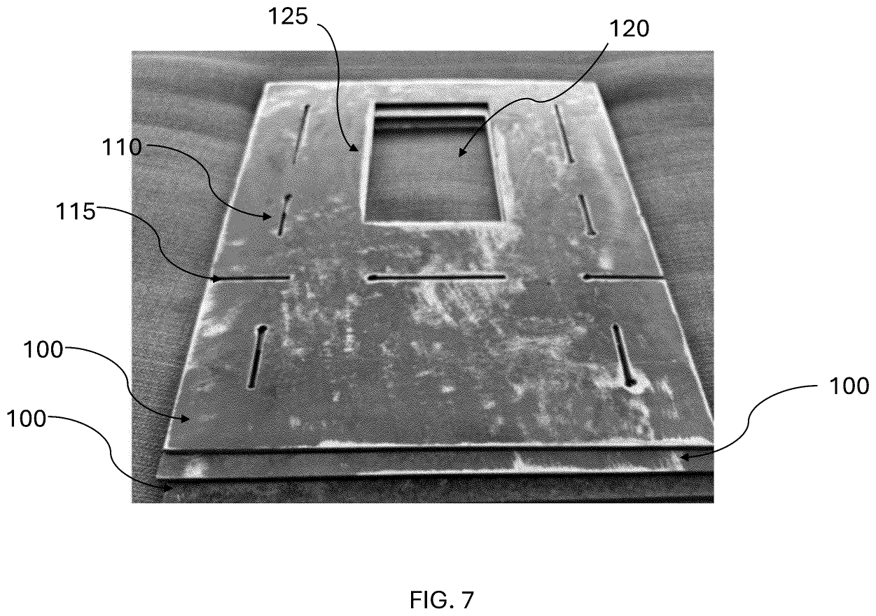

FIG. 7 depicts a front perspective view of several illustrative electrical receptable brackets stacked onto one another. The stowage mode of bracket 100 may allow, for example, several brackets 100 to be stacked onto one another. These stacks of brackets 100 may, for example, be stored in boxes and/or shipping containers in order to be transported.

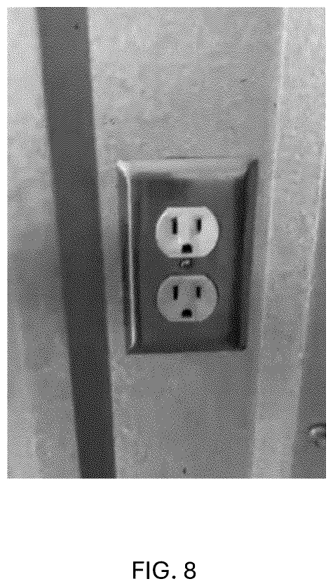

FIG. 8 depicts an illustrative embodiment of an installed electrical receptable bracket. The bracket 100 may, for example, be installed on the wall. For example, the bracket 100 in FIG. 8 is on the other side of the wall. From this position, the bracket 100 may, for example, provide structural support to the outlet box 205 and the internal electrical components.

Although an illustrative system has been described with reference to FIGS. 1-8, other implementations may be deployed in other industrial, scientific, medical, commercial, and/or residential applications.

In accordance with an illustrative embodiment, the bracket 100 may, for example, be utilized in aircrafts, vehicles, and boats. The flexibility and strength of the bracket 100 advantageously provides an adaptable design that may be used in a variety of environments, including in vehicles. With the increasing need for outlets in personal and commercial vehicles, the bracket 100 may, for example, be installed in these vehicles as the brackets can be flexibly arranged to adapt to the environment of the vehicle.

A number of implementations have been described. Nevertheless, it will be understood that various modifications may be made. For example, advantageous results may be achieved if components of the disclosed systems were combined in a different manner or if the components were supplemented with other components.

I claim:

1. A metal bracket comprising a die-cut electrical receptacle having a horizontal folding guideline and a vertical folding guideline, also having a stackable flat stowage mode, and also having a folded non-flat assembled mode in which the bracket is configured to receive an electrical outlet box.
